(19) United States
(12) Patent Application Publication
(10) Pub. No.: US 2011/0096126 A1
(43) Pub. Date: Apr. 28, 2011

(54) PRINTER HEAD AND PRINTING METHOD HAVING THE SAME

(76) Inventors: Jin-Soo JUNG, Gyeonggi-do (KR); Baek-Kyun Jeon, Gyeonggi-do (KR); Bong-Sung Seo, Gyeonggi-do (KR); Byoung-Hun Sung, Gyeonggi-do (KR)

(21) Appl. No.: 12/979,252

(22) Filed: Dec. 27, 2010

Related U.S. Application Data
(62) Division of application No. 12/347,824, filed on Dec. 31, 2008.

(30) Foreign Application Priority Data
May 14, 2008 (KR) 10-2008-44531

(51) Int. Cl. B41J 2/045

(52) U.S. Cl. 347/71

(57) ABSTRACT

In an apparatus and a method for the printing of spacers in a pattern on substrates of display panels, a printer head includes a plurality of nozzle holes. Each printer head includes a nozzle group having a plurality of nozzle holes. A nozzle group may be selected by the conduction wirings on the vibration membrane and top plate sandwiching the piezoelectric actuators. To print complex patterns on the substrate a plurality of printer head sets, a plurality of printer heads in a line, can be arranged in various configurations.

This application is a divisional of U.S. patent application Ser. No. 12/347,824 filed on Dec. 31, 2008, which claims priority to Korean Patent Application No. 2008-44531, filed on May 14, 2008, and all the benefits accruing therefrom under 35 U.S.C. §119, the contents of which in their entirety are herein incorporated by reference.

### BACKGROUND OF THE INVENTION

1. Field of the Invention

The present invention relates to liquid crystal display (LCD) panels. More specifically, the present invention relates to a printer head and method for printing patterns on substrates of LCD panels.

2. Description of the Related Art

LCD displays are currently the most widely used type of flat panel display, and typically include a display panel having two substrates between which a layer of liquid crystal materials is sealed. The upper and lower substrates of an LCD panel are coupled together with a sealant that extends around a peripheral edge of the two substrates. A plurality of spacers is disposed between the upper and lower substrates to hold a uniform space, called a “cell gap,” between the substrates.

In general, these spacers are generally spherical spacers made of a material which contains resin or glass, or a similar material. Such spacers are scattered along inner surfaces of the insulating substrate by a spray method or the like. Another method of spacer placement employs a photolithographic technique. This technique provides a predetermined pattern of spacers formed on a part of an area shielded from light. Photolithographic techniques can yield spacers of more regular shape and size, and can place them in more precise positions, as compared to spherical spacers made by spraying methods.

Accordingly, it is desirable to improve spraying methods so that, like photolithographic techniques, spraying methods can produce better spacers that are also placed more precisely.

### SUMMARY OF THE INVENTION

The invention can be implemented in a number of ways, including as an apparatus and a method. In one embodiment, a printer head for fabrication of a display panel comprises a nozzle unit, a plurality of nozzle holes on the nozzle unit, and a plurality of piezoelectric actuators that correspond to the plurality of nozzle holes. A first membrane is disposed between the plurality of piezoelectric actuators and the nozzle holes. A second membrane is disposed on an opposite side of the piezoelectric actuators from the first membrane, so as to apply a driving voltage to the piezoelectric actuators. A first conductive wire on the first membrane groups the plurality of nozzle holes, and a second conductive wire on the second membrane groups the piezoelectric actuators corresponding to the grouped nozzle holes.

In another embodiment, a printing apparatus for fabrication of a display panel comprises a plurality of printer heads covering at least one side of the substrate, and a plurality of printer head sets aligned in a plurality of lines, each printer head set having nozzle holes. Said plurality of printer head sets is arranged so that alternating sets of the nozzle holes have alternating displacements.

In another embodiment, a printing method for fabrication of display panel comprises selecting a nozzle group, and supplying a driving voltage to the selected nozzle group by at least one conductive wire in electrical communication with the first and second membrane, so as to form spacers by ejecting drops from the selected nozzle group. The selecting of a nozzle group determines a spacer size and distance between the spacers.

In another embodiment, a printing method comprises aligning a plurality of printer head sets in plural lines, and adjusting an nth printer head set by a distance corresponding to 1/n (n=1, 2, 3 . . . ) in a first direction. Droplets of ink are then ejected from a selected nozzle group of a first printer head set. Droplets of ink are also ejected from a selected nozzle group of a subsequent printer head set. A jet interval between said selected nozzle group of the first printer head set and said selected nozzle group of the subsequent printer head set is selected according to a distance in a second direction generally perpendicular to the first direction.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The present invention will become readily apparent by reference to the following drawings wherein:

FIG. 1A is a schematic view illustrating a printing method employing a printer head.

FIG. 1B is a schematic view illustrating rotating the printer head shown in FIG. 1A.

FIG. 2 is a schematic view illustrating an exemplary ink jet printing apparatus.

FIG. 3 is a schematic view illustrating an exemplary printer head.

FIG. 4 is a cross section view illustrating an exemplary printer head.

FIG. 5 is a plan view illustrating an exemplary top plate and vibration membrane according to the present invention.

FIG. 6 is a plan view illustrating an exemplary fluid path plate according to the present invention.

FIG. 7A is a schematic view illustrating an exemplary method of ink jet printing using a nozzle unit according to the present invention.

FIG. 7B shows a top view of the exemplary nozzle unit 100 of FIG. 7A, as well as another exemplary ink jet printing method.

FIG. 8 is a schematic view illustrating an exemplary printer head set according to the present invention.

FIG. 9 is a schematic view illustrating an exemplary method of ink jet printing using a plurality of printer head sets according to the present invention.

FIG. 10 is a plain view illustrating an exemplary embodiment of a nozzle unit with different nozzle sizes according to the present invention.

### DETAILED DESCRIPTION OF THE INVENTION

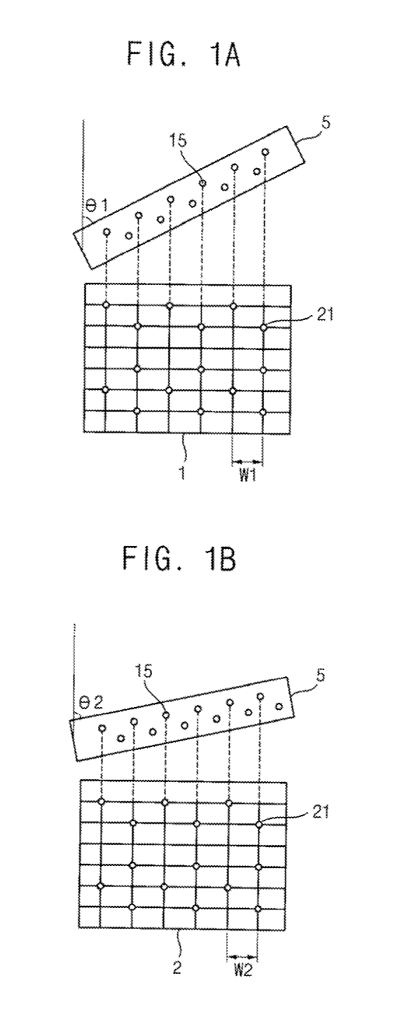

FIG. 1A is a schematic view illustrating a printing method employing a printer head.

Referring to FIG. 1A, a printer head 5 is positioned to spray drops on at least one side of working substrate. The printer head 5 has nozzle holes 15 that it positions so as to spray drops in a predetermined pattern. In FIG. 1A, a reference numeral w1 represents a drop pitch between adjacent drop patterns 21. The drop pitch w1 between the adjacent drop patterns 21 is substantially equal to a distance between adjacent nozzle holes 15 with respect to a longitudinal direction of the working substrate 1. The printer head 5 is inclined with respect to the longitudinal direction by an angle of θ1.

FIG. 1B is a schematic view illustrating rotating the printer head shown in FIG. 1A.

Referring to FIG. 1B, the drop pitch can be varied by rotating the printer head 5, since the drop pitch w2 between adjacent drop patterns 21 on a substrate 2 will vary with angle θ2 between the printer head 5 and the longitudinal direction.

However, rotating head configurations suffer from drawbacks. For example, it is still difficult to make precise patterns by adjusting rotating angle and jet timing synchronously. Jet time must be controlled separately hole by hole with rotating angle by this method.

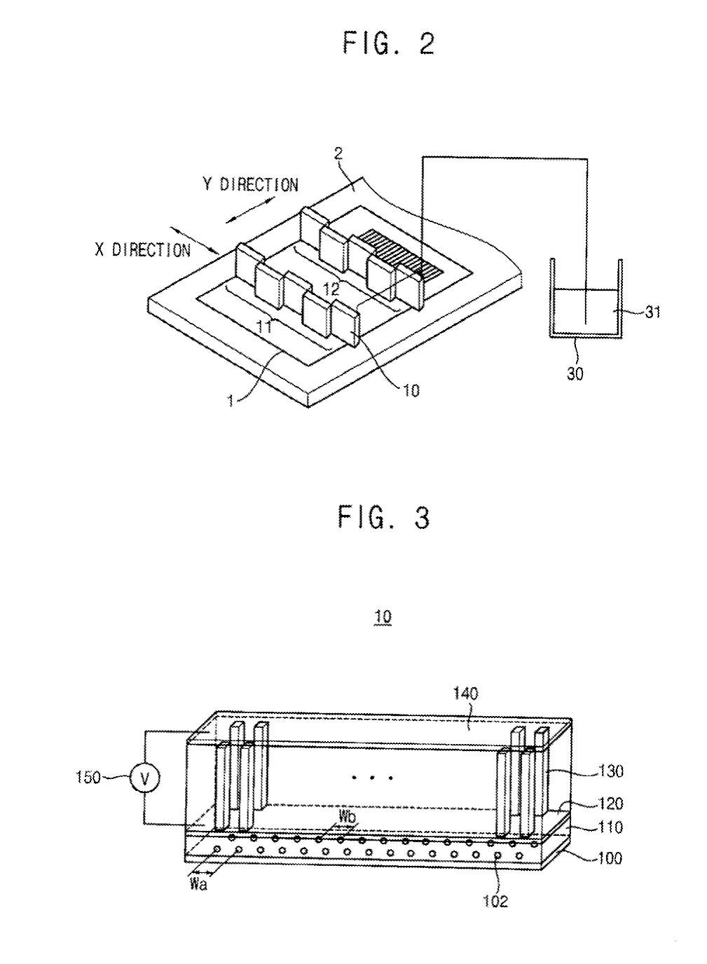

An exemplary embodiment of the invention provides an ink jet printing apparatus as shown in FIG. 2.

Referring to FIG. 2, at least one spacer solution tank 30 is included to supply spacer solution 31 to any set 11 and 12 of printer heads. Each set 11 and 12 includes a plurality of printer heads 10 placed in the x direction to cover at least one side of the substrate 1. The plurality of ink jet printer head sets 11 and 12 may also be placed in the y direction to create any pattern desired.

The printer head sets 11 and 12 may move over the substrate 1 in the x direction or perpendicular y direction to print patterns on the substrate 1. Alternatively, the stage 2 of the ink jet printing apparatus may move the substrate 1 in the x direction or y direction while the printer head sets 11 and 12 remain in a fixed position. In other embodiments of the invention, both the printer head set 11 and 12 and the stage 2 can move to create a variety of drop patterns.

FIG. 3 is a detailed illustration of a printer head 10 of an exemplary embodiment of the present invention.

Referring to FIG. 3, the printer head 10 includes a nozzle unit 100 to control the distance of drop point and droplet size. The printer head 10 also includes a fluid path plate 110, vibration membrane 120, top plate 140 and a plurality of piezoelectric actuators 130.

In operation, an oscillatory driving signal 150 is applied between top plate 140 and vibration membrane 120. Piezoelectric actuators 130 vibrate at the frequency of the driving signal 150, pushing out ink droplets from chamber through nozzle holes.

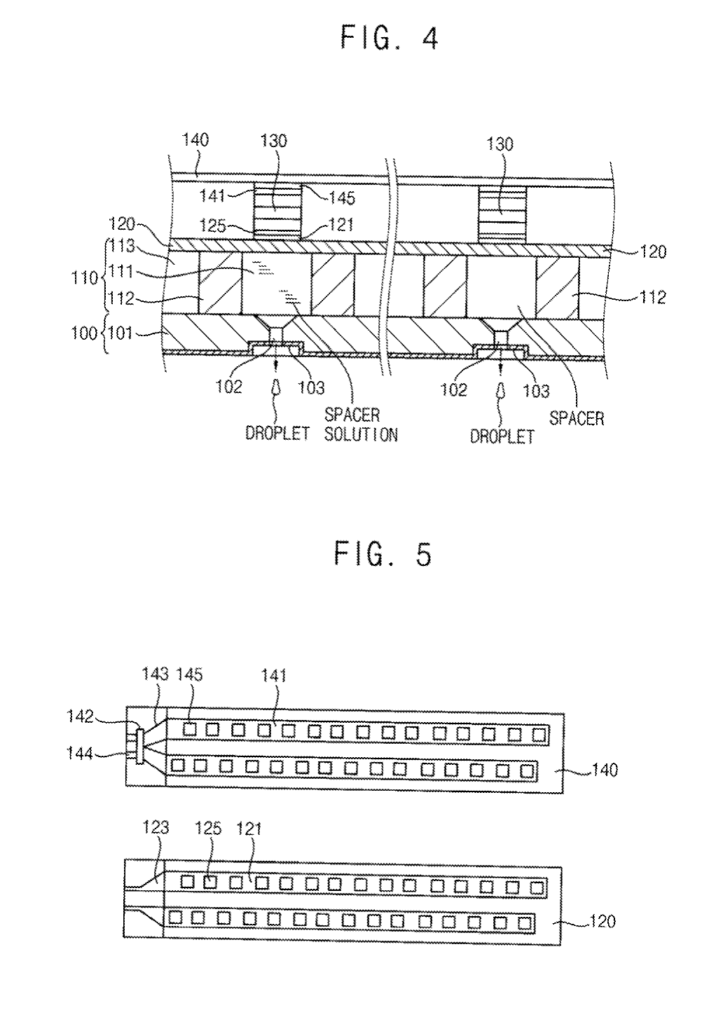

A cross section view of the exemplary printer head 10 is shown in FIG. 4.

Referring to FIG. 4, a nozzle unit 100 includes an ink repellant layer 102 and a plurality of nozzle holes 103. A fluid path plate 110 includes an ink chamber 111, a partition wall 112 and a reservoir 113.

An electrically conductive wiring 121 may be deposited on the vibration membrane 120 and the top plate 140, to induce a driving voltage on a group of piezoelectric actuators 130.

An exemplary layout of the electrically conductive wiring 121 is shown in FIG. 5.

Referring to FIG. 5, the electrically conductive wiring 121 can be fabricated using any method, for example electrical plating, sputtering, chemical vapor deposition or roll printing. A top plate 140 and a vibration membrane 120 may include a plurality of contact electrodes 125 that decrease contact resistance between piezoelectric actuators 130 and conductive wiring 121. A plurality of pad lines 141 fans out to a plurality of conductive wirings 121 from the IC chip 142 located in a side of top plate 140. The first lead lines 143 are formed to connect printer head 10 to voltage source 150. IC chip 142 may control selective voltage distribution to conductive wirings 121. A plurality of conductive wirings 121 and a plurality of contact electrodes 125 are deposited on the vibration membrane 120, similar to those on the top plate 140. For example, a plurality of contact electrodes 145 may also be formed on the top plate 140. The second lead lines 123 are formed on the vibration membrane 120 in a layout corresponding to the first lead lines 143.

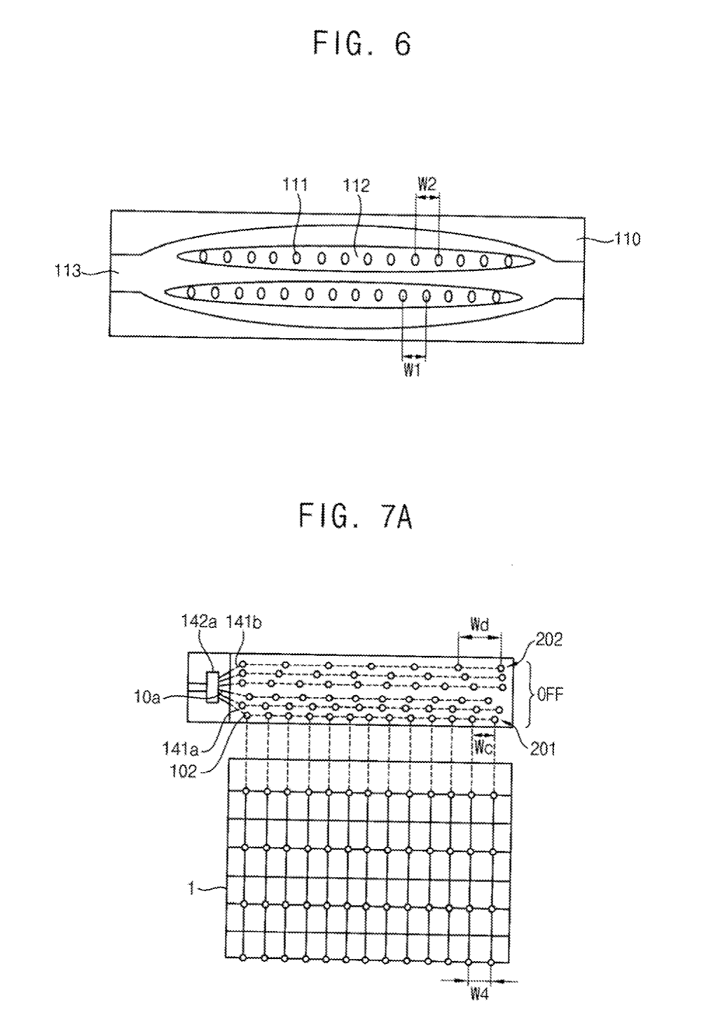

FIG. 6 is an illustration of an exemplary fluid path plate 110.

Referring to FIGS. 4 and 6, a fluid path plate 110 includes a reservoir 113, a partition wall 112 and a plurality of ink chambers 111. Spacer solution flows into the reservoir 113 from a liquid supply system, where it travels to the ink chambers 111 by the action of vibration membrane 120.

In FIG. 6, the ink chambers 111 of the fluid path plate 110 are aligned along two lines, and a distance wa between adjacent ink chambers 111 in a first line is substantially the same as a distance wb between adjacent ink chambers 111 in a second line. Alternatively, the ink chambers 111 of the fluid path plate 110 may be aligned in a single line.

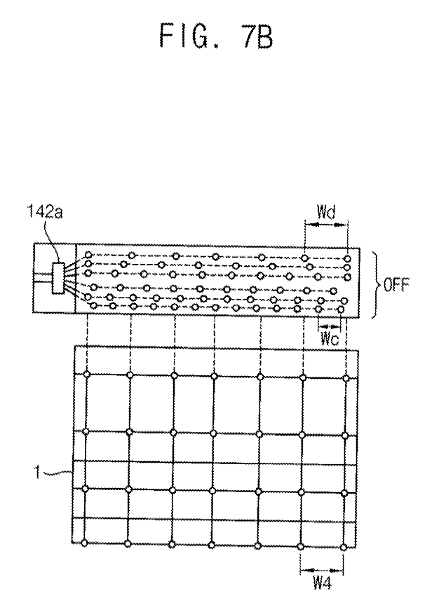

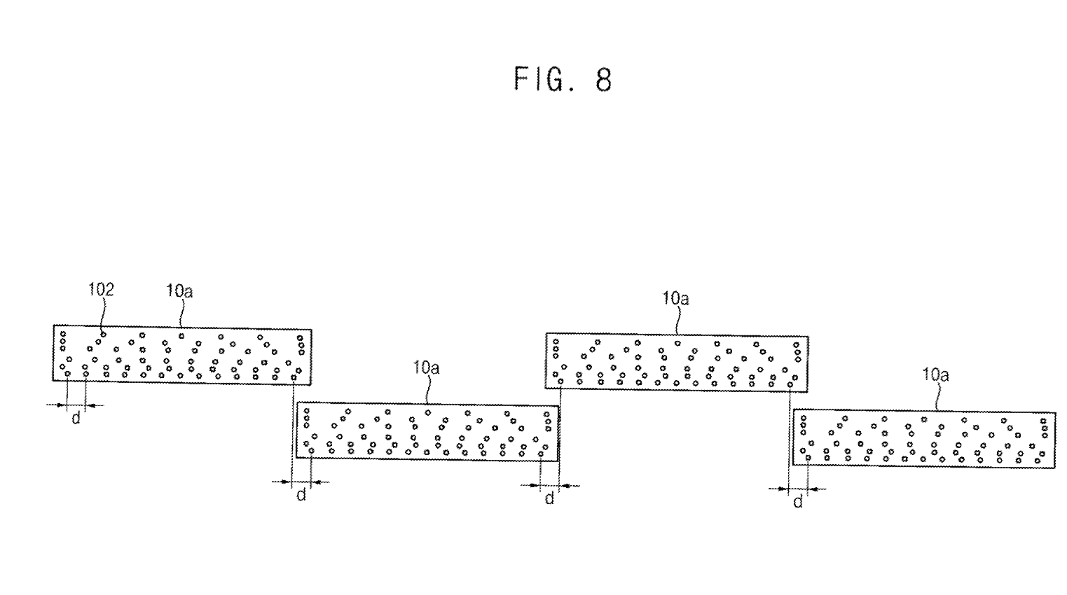

FIG. 7A shows a top view of an exemplary nozzle unit 100 of the present invention, as well as an exemplary ink jet printing method.

Referring to FIG. 7A, this method does not require rotating operation of a printer head 10a. A nozzle unit 100 may have several lines of nozzle holes 102 and these lines can be grouped as desired.

The nozzle holes 102 in different nozzle groups 201 and 202 have different intervals wc and wd. For example, the nozzles holes 102 in a lowermost nozzle group 201 has an interval of wc that is smaller than an interval wd between the nozzles holes 102 in an uppermost nozzle group 201.

The printer head 10a ejects droplets on a working substrate 1 through the nozzle group 201 having the interval wc that is substantially the same as a distance w3 between adjacent pixels of the working substrate 1. In FIG. 7A, the distance between the adjacent pixels of the working substrate 1 is substantially the same as the interval wc between adjacent nozzle holes 102 in the lowermost nozzle group 201.

The IC chip 142) can apply a separate driving voltage to each nozzle group 201 and 202 independently by selecting the appropriate conductive wirings 121. By designing the structure of nozzle group 201 and 202, printer head 10 can be adapted to a variety of patterns depending on processing devices. In FIG. 7A, each nozzle group 201 and 202 is selectively operated by the IC chip 142a. Alternatively, each nozzle group 201 and 202 may be selectively operated by a driving circuit (not shown) that is spaced apart from the printer head 10a.

The most appropriate nozzle group can then be selected for a particular operation. When a nozzle group 201 and 202 opens and ejects droplets of spacer solution, the other nozzle groups 201 and 202 can be closed.

FIG. 7B shows a top view of the exemplary nozzle unit 100 of FIG. 7A, as well as another exemplary ink jet printing method.

Referring to FIG. 7B, when a distance w4 between adjacent pixels of a working substrate 1 is changed, different nozzle group 202 corresponding to the distance w4 between the adjacent pixels is selected from the nozzle groups 201 and 202.

For example, a voltage is applied to the conductive line 141b disposed on the uppermost part of the printer head 10a by the IC chip 142a so that the printer head 10a ejects droplets through the nozzle group 202 having the distance wd that is substantially the same as the distance w4 between the adjacent pixels of the working substrate 1.

In FIG. 7B, the distance w4 between the adjacent pixels of the working substrate 1 is substantially the same as the distance wd between adjacent nozzle holes 102 of the uppermost nozzle group 202.

FIG. 8 is a schematic view illustrating an exemplary printer head set according to the present invention. In FIG. 8, printer heads are substantially the same as shown in FIGS. 7A and 7B. Thus, any repetitive explanation concerning the above-mentioned elements will be omitted.

Referring to FIG. 8, a plurality of printer heads 10a can be arranged in a line, constituting a set 11 and 12 of printer heads to cover the entire pattern of the substrate by the ink jet printing apparatus, as shown in FIG. 8. A plurality of printer heads 10a can be overlapped alternately at their end portions, providing a constant nozzle pitch ‘d’ between neighboring printer heads. If the printer heads 10a do not overlap at the end portion, nozzle pitch between the end holes of neighboring printer heads becomes larger than that of an inner portion of the printer heads. The distance between spacers typically ranges from about a few gm to a few mm.

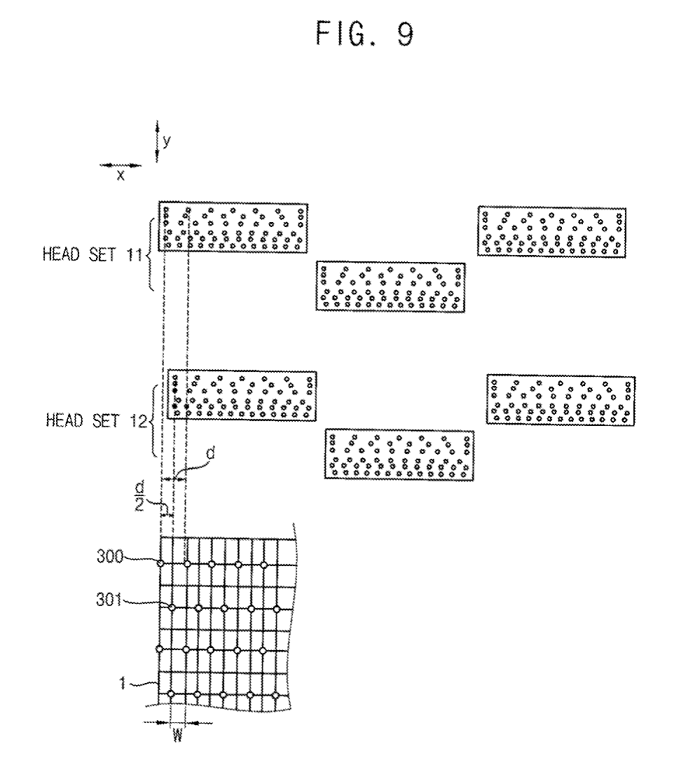

FIG. 9 is an illustration of an exemplary ink jet printing method.

Referring to FIG. 9, sets 11 and 12 of printer heads can be disposed in different lines to create more complex patterns. For example, when the second line patterns 301 need to be disposed a half distance d/2 offset in the x direction against the first line pattern 300, the set 11 of printer heads in the following line of a printer head set 12 can be shifted a half distance d/2 in the x direction. For example, d/n may be substantially the same as the distance w between adjacent pixels. If a working substrate 1 on a stage of the ink jet apparatus moves with sets 11 and 12 of printer heads fixed, the speed of the stage toward the printer heads must be controlled, with respect to jet time, to match the predetermined position. As the speed of the stage increases, the interval time between a jet time of the front set 12 of printer heads and a jet time of the rear set 11 of printer heads must be reduced.

The size of the spacer needs to be adjusted so as to sustain sufficient loading between the upper and lower substrate. If the distance between neighbor spacers gets larger, then larger spacers are needed. The size of the spacer depends on the volume of droplet ejected from the nozzle hole of printer head.

The size of nozzle hole 102 determines the ejected volume of the droplet. Thus, the size of nozzle hole 102 is determined by the required size of the spacers.

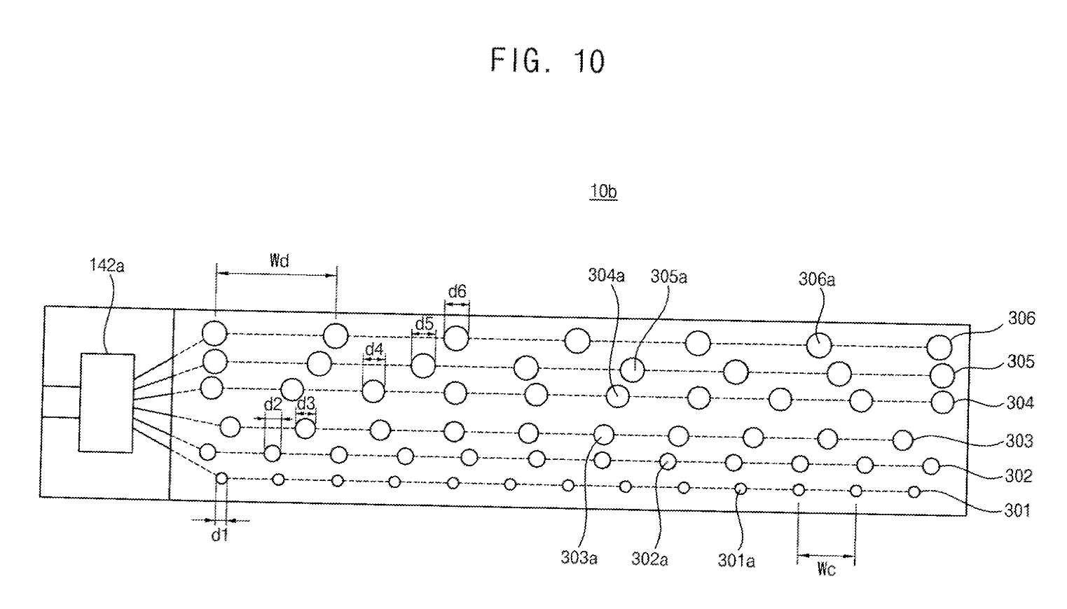

FIG. 10 is one embodiment of nozzle unit 100. Nozzle holes 102 are fabricated for a 40 inch to 82 inch device model.

Referring to FIG. 10, the printer head 10b includes a plurality of nozzle groups 301, 302, 303, 304, 305 and 306. Each of the nozzle groups 301, 302, 303, 304, 305 and 306 includes a plurality of nozzle holes 301a, 302a, 303a, 304a, 305a and 306a.

In FIG. 10, the nozzle holes 301a, 302a, 303a, 304a, 305a and 306a of different nozzle groups 301, 302, 303, 304, 305 and 306 are spaced apart from each other by different distances wc and wd. For example, the distance wc between adjacent nozzle holes 301a of the lowermost nozzle group 301 is smaller than the distance wd between adjacent nozzle holes 306a of the uppermost nozzle group 306.

The nozzle holes 301a, 302a, 303a, 304a, 305a and 306a of the different nozzle groups 301, 302, 303, 304, 305 and 306 may have different diameters d1, d2, d3, d4, d5 and d6. For example, when the distance between adjacent nozzle holes is increased, the diameter of each nozzle hole may be increased.

It is desirable that the size of the nozzle holes 102 is the same within the same nozzle group 301, 302, 303, 304, 305 and 306 but it is different from that of the other nozzle groups 301, 302, 303, 304, 305 and 306.

The foregoing description, for purposes of explanation, used specific nomenclature to provide a thorough understanding of the invention. However, it will be apparent to one skilled in the art that the specific details are not required in order to practice the invention. In other instances, well known devices are shown in block form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Rather, many modifications and variations are possible in view of the above teachings. For example, the invention contemplates the formation of spacers of any size and material. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A printer head for fabrication of a display panel, the printer head comprising:
a nozzle unit;
a plurality of nozzle holes on the nozzle unit;
a plurality of piezoelectric actuators that correspond to the plurality of nozzle holes;
a first membrane disposed between the plurality of piezoelectric actuators and the nozzle holes;
a second membrane disposed on an opposite side of the piezoelectric actuators from the first membrane, so as to apply a driving voltage to the piezoelectric actuators;
a first conductive wire on the first membrane grouping the plurality of nozzle holes; and
a second conductive wire on the second membrane grouping the piezoelectric actuators corresponding to the grouped nozzle holes,
wherein a first group of the nozzle holes are spaced apart at a first pitch, and a second group of the nozzle holes are spaced apart at a second pitch smaller than the first pitch, and the nozzle holes of the first group have a size greater than the nozzle holes of the second group.

2. The printer head according to claim 1,
wherein at least one of said first and second conductive wires includes a plurality of contact electrodes to decrease contact resistance between said first and second conductive wires and of the grouped piezoelectric actuators.

3. The printer head according to claim 1,
wherein the first membrane or the second membrane includes at least one IC chip to control the driving voltage.

4. The printer head according to claim 3,
wherein the first membrane or the second membrane includes a fan out portion of electrical connectors from the IC chip to the conductive wire.
